(19) United States
(12) Patent Application Publication
(10) Pub. No.: US 2010/0274420 A1
(43) Pub. Date: Oct. 28, 2010

(54) METHOD AND SYSTEM FOR CONTROLLING PROPULSION SYSTEMS

(75) Inventors: Frank William Veit, Erie, PA (US); Jeffrey Louis Daigle, Erie, PA (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: GENERAL ELECTRIC COMPANY, Schenectady, NY (US)

(21) Appl. No.: 12/429,973

(22) Filed: Apr. 24, 2009

(51) Int. Cl. G05D 1/00; B63H 21/21; B63H 23/32

(52) U.S. Cl. 701/21; 440/1; 440/75

(57) ABSTRACT

Methods and systems are provided for controlling a propulsion system of a vessel including an engine and a propeller. In one embodiment, the method comprises independently adjusting each of an engine setting and a propeller setting responsive to real-time vessel operating data.

### FIELD

The subject matter disclosed herein relates to methods and systems for controlling propulsion systems, such as marine propulsion systems.

### BACKGROUND

Marine propulsion systems, such as those on tugboats, enable a vessel to be easily and rapidly maneuvered in response to sudden and widely varying changes in load, direction, speed, etc. In some examples, propulsion control can be provided by adjusting propeller pitch and torque in a predetermined relationship based on a requested engine speed.

However, propeller performance and engine performance are largely dictated for a given propeller design by variables including propeller pitch, rotational speed, and speed of advance in water. Variables such as speed of advance in water are, in turn, variably dependent on external influences such as wind load, sea load, towing load, and the like. The inventors herein have recognized that the high degree of variability of these loads can thus make it difficult for propulsion control to maintain an efficient combined use of both engine and propeller under the range of actual working conditions encountered.

Specifically, as noted above, currently available propulsion control matches engine speed to the requested speed by regulating the amount of fuel needed to produce the torque and/or power for maintaining the requested speed. Propeller settings are then adjusted as a function of the engine speed. Engine speed is held at the requested amount even as torque loads vary. Since lowest fuel consumption is dependent on both speed and load, an engine holding speed while loads vary may be unable to operate at peak efficiency. Furthermore, due to lack of knowledge regarding the optimal operating conditions of the prime movers (e.g., engine, motor, or other source of power for propulsion) across the entire range of operation, propeller torque is often imperfectly matched to engine speeds, resulting in reduced propeller efficiency and thus further degraded fuel consumption, especially when actual operating conditions vary widely from the assumed average conditions.

### BRIEF DESCRIPTION OF THE INVENTION

Methods and systems are provided for improving the efficiency of a vessel's propulsion system by dynamically reconfiguring propulsion system settings in response to varying vessel operating conditions. In one embodiment, the method includes independently adjusting each of an engine setting and a propeller setting responsive to real-time vessel operating data. The “real-time” vessel operating data refers to actual measurements and estimates of various vessel operating conditions under the prevalent conditions. Herein, independent adjustment means that adjustment of the engine setting does not necessarily require adjustment to the propeller setting, and vice versa. In another embodiment, the method includes adjusting an engine setting responsive to real-time vessel operating data and adjusting a propeller setting responsive to real-time vessel operating data, wherein the propeller is adjusted independently from the engine during vessel operation. The settings adjusted may include at least an engine speed setting and a propeller pitch setting.

In one example, a propulsion system is configured with a controllable pitch propeller. In response to an operator power request, vessel operating data are estimated in real-time. The estimated data includes an estimate of the prevalent propeller torque (for example, using a torsion meter, or sensor, mounted on the propeller shaft, or inferred from the motor current of a propeller's pitch controller), propeller pitch, engine speed, and other vessel operating conditions (such as speed of advance in water). The estimated data is then used to update a propeller performance map (or performance curve), and an engine performance map (or performance curve). A multi-variable optimization routine based on the updated maps then enables propeller pitch and engine speed adjustments to be determined that can improve propeller efficiency and/or engine efficiency, or overall efficiency. As such, more than one adjustment to engine speed and/or propeller pitch may improve engine and/or propeller efficiency, or overall efficiency. A controller can select a propeller pitch and engine speed adjustment combination, from the range of adjustment possibilities, based on performance characteristics desired. In this way, propeller pitch and engine speed settings can be varied independently from one another. In one example, propeller pitch and engine speed are not set in a 1:1, fixed relationship. Consequently, adjustments to propeller pitch settings may not necessitate substantially equal and/or compensatory adjustments to engine speed settings, and vice versa. In one example, during acceleration, settings may be selected that enable enhanced engine performance, including an expedited response time and/or greater fuel savings. In another example, during a steady state mode of operation, settings may be selected that enable enhanced propeller performance.

In another example, a propulsion system is configured with a fixed pitch propeller. Herein, a DC bus positioned intermediate the engine and the propeller enables engine performance to be decoupled from propeller performance, and allows the engine and propeller settings to be independently adjusted and optimized based on real-time vessel operating data. During steady state operation, in response to a power request, engine settings can be adjusted based on updated engine efficiency and fuel maps. Specifically, the multivariable optimization routine can select engine speed and torque settings that enable the requested power to be supplied most efficiently. During acceleration, engine settings can be adjusted to provide greater fuel savings. Propeller settings, such as propeller speed, may then be adjusted based on engine settings.

In yet another example, a propulsion system is configured with a hybrid drive system, including an alternator, and an electric motor linked to the propeller shaft. Herein, the alternator-motor combination is used to decouple engine and propeller performances, such as engine and propeller loads, so that they may be independently adjusted and optimized. Specifically, engine torque can be adjusted by receiving power from a battery during loaded operations, and using the engine to charge the battery during light loads. The optimization routine can further select an optimal motor-generator to propeller power split based on real-time vessel operating data, including a real-time estimate of the propeller torque.

In this way, engine and propeller settings may be adaptively and independently reconfigured, based on the speed and/or power requested, and further based on real-time vessel operating data, to thereby enable both engine and propeller performances to be independently optimized. By further biasing the adjustments to engine and/or propeller settings responsive to a vessel mode of operation and/or selected vessel performance characteristics, engine and propeller performances may be improved.

Additionally, or alternatively, a hybrid drive system configuration can be provided comprising a first engine, a second engine, a first electric machine coupled to the first engine, a first propeller having a first propeller shaft, wherein the first propeller shaft is coupled to the first electric machine, a second electric machine coupled to the second engine, and a battery coupled to each of the first and second electric machines through an electrical power distribution system. The hybrid drive system may further include a control system having computer readable storage medium with code therein, the code configured to dynamically adjust operation of the propulsion system responsive to vessel operating conditions.

The hybrid drive system may enable engine and propeller performances to be decoupled, for example, by decoupling engine and propeller loads, so that the engine and propeller performances may be independently adjusted and optimized. For example, the engine torque may be adjusted by receiving power from a battery during loaded operations, and then charging the battery during lighter loads. Also, the hybrid drive system may be adjusted to meet transient load changes with stored electrical energy and/or to reconfigure power distribution between auxiliary and propulsion circuits responsive to changes in power demand as well as engine and/or propeller operating conditions (such as during engine and/or propeller degradation). In doing so, a flexible and reconfigurable system may be provided that increases system reliability.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The present invention will be better understood from reading the following description of non-limiting embodiments, with reference to the attached drawings, wherein below:

FIG. 1 shows an example embodiment of a marine propulsion system including a controllable pitch propeller;

FIG. 2 shows an example embodiment of a marine propulsion system including a series hybrid drive system;

FIGS. 3A-D show example embodiments of a marine propulsion system including a parallel hybrid drive system;

FIG. 4 shows a high level flow chart for optimizing propulsion system efficiency according to the present disclosure;

FIG. 5 shows a high level flow chart for an example optimization routine; and

FIG. 6 shows a high level flow chart for an example reconfiguration routine.

### DETAILED DESCRIPTION

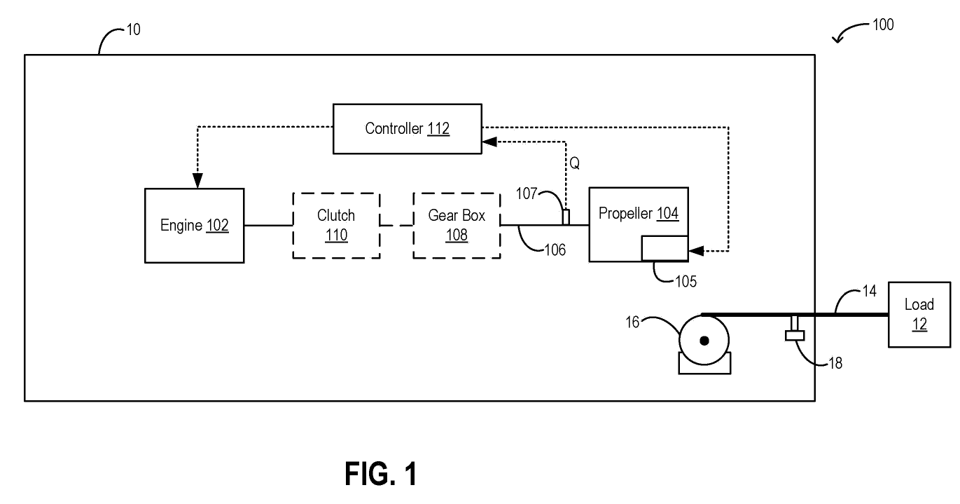

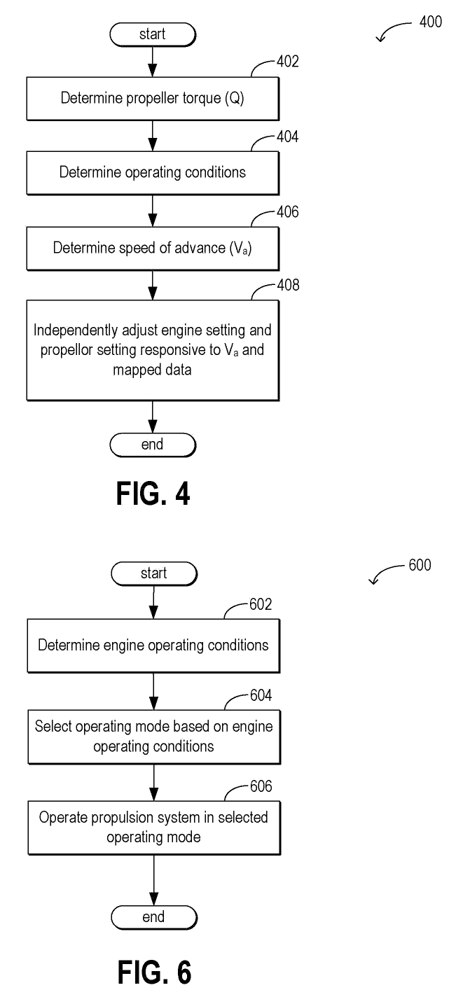

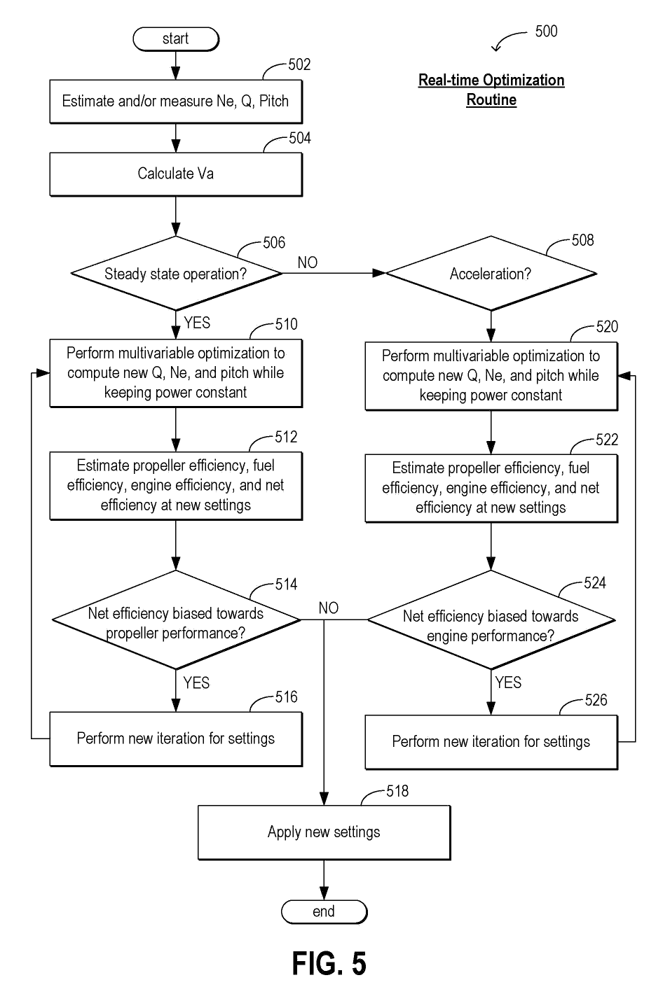

Marine propulsion systems, such as those depicted in FIGS. 1-3D, in vessels such as tugboats, are controlled by propulsion control programs. Based on real-time knowledge of vessel operating conditions (such as propeller torque, engine speed, speed of advance in water, etc.), engine and propeller settings can be independently and dynamically adjusted to enable engine and propeller performances to be better matched. As such, differing variables affect engine and propeller performances in substantially different ways. Thus, by performing a multivariable optimization routine, such as those depicted in FIGS. 4-5, wherein both engine and propeller settings are independently reconfigured in response to real-time vessel operating data, the performances of both the engine and the propeller of a vessel propulsion system are improved, thereby enhancing the overall efficiency of the propulsion system. Furthermore, by performing a reconfiguration routine, such as depicted in FIG. 6, wherein the system power output is dynamically reconfigured between system components (such as between a plurality of system engines and/or system batteries), the reliability of the propulsion system may be increased without increasing redundancy in system components.

FIG. 1 describes a first embodiment 100 of a marine propulsion system housed in a marine vessel 10. As depicted herein, marine vessel 10 may be a tugboat. The tugboat is configured to directly push, tow and/or steer a load 12, such as another vessel. In one example, as depicted, the direct pushing, towing and/or steering may be enabled using a towing cable 14. However, in alternate examples, no cable may be needed. When present, towing cable 14 may be connected to towing winch 16 with towing eyelet 18 providing traction to the cable.

In one example, marine vessel 10 is a diesel electric tugboat operating a diesel engine 102. However, in alternate embodiments, alternate engine configurations may be employed, such as a gasoline engine, a turbine engine, or a biodiesel or natural gas engine, for example. Engine 102 generates a torque that is transmitted to propeller 104 along a propeller shaft 106. In the depicted example, propeller 104 is a controllable pitch propeller (CPP). A torsion meter 107, or sensor, mounted on propeller shaft 106 provides a real-time estimate of propeller torque (Q) to controller 112. Torsion meter 107 may be located at any position along propeller shaft 106. Based on the location, appropriate multipliers may be applied to account for the gear ratio and bearing losses. The real-time estimate of propeller torque, as provided by the torsion meter, is a measure of the actual torque being absorbed by the propeller under the current propeller settings. As such, propeller torque may also be inferred and/or estimated from propeller rotational speed and vessel speed using theoretical and/or model-tested propeller torque curves. However, such methods of torque measurement may suffer from inaccuracies due to difficulties incurred in updating the maps, based on all the widely varying vessel conditions during sea trials. Thus, the torsion meter measured torque may provide a more accurate measurement of propeller torque and constitutes one of the real-time operating data used by an engine controller in optimization routines. As further elaborated herein, the propeller torque so measured may be used with propeller speed measurements to estimate a propeller speed of advance and efficiency from propeller design curves. In this example, a gear box 108 and a clutch 110 may optionally be provided along propeller shaft 106, specifically in between engine 102 and propeller 104, to enable torque modulation between engine 102 and propeller 104.

In response to a speed and/or power request (which is from the pilot settings in one example), controller 112 can independently adjust engine settings, such as an engine speed setting and/or engine torque setting, and propeller settings, such as propeller pitch setting, rotational speed setting, and propeller torque setting. That is, engine and propeller settings can be adjusted without a direct correlation (for example, a 1:1 fixed relationship) between the settings. Consequently, adjustments to propeller settings may not necessitate substantially equal and/or compensatory adjustments to engine settings, and vice versa. Controller 112 can adjust propeller settings by controlling the motor of propeller pitch controller 105, for example. In one example, the controller includes a power reference (such as a power range) setting, based on the power request. Alternatively, the controller may include a speed reference setting (such as a desired speed and/or rate of acceleration). As such, a power reference may be more desirable since a larger range of settings (and/or combinations of settings) can provide the requested power. Controller 112 may then select among the range of possible settings based on other considerations, such as a mode of operation, a setting for fuel economy, a setting for rapid response, etc.

The range of possible settings is determined by the controller based on propeller performance and engine performance maps. Pilot engine and propeller performance maps can be generated based on model-tested data, and further based on pilot settings (for example, those initially input by an operator). Propeller performance maps may correlate, for example, a propeller pitch to an output speed (RPM) for various thrust levels. Engine and/or propeller settings may be based on such a performance map by choosing a desired RPM and thrust level and then adjusting the propeller pitch to the value stated in the map. A pilot performance map is generated in the first instance based on parameters such as the design or configuration of the propeller, standard physics equations, mathematical models, etc. relating to how such a propeller design interacts with water and/or air, laboratory testing of the propeller under controlled conditions, and/or assumed variables or conditions. In certain embodiments of the present invention, the performance maps are updated by collecting real time operation data and then plugging the real time data into the underlying physics equations, mathematical models, etc. in place of assumed or controlled data. Settings are then adjusted based on the updated performance maps. Since different variables can affect engine and propeller performances in substantially different ways, in response to a speed and/or power request, a controller may be configured to collect real-time vessel operating data (that is, actual measurements and estimates of various vessel operating conditions under the prevalent conditions) and update the pilot performance maps. By updating the performance maps responsive to real-time data, more reliable engine and propeller performance are obtained. By using such updated maps to independently adjust engine and propeller performance settings, combinations of settings can be achieved wherein both engine and propeller performances are individually optimized, and better matched. Thus, the overall efficiency of the vessel is significantly improved.

As further elaborated herein with reference to the optimization routines of FIGS. 4-5, the combination of settings selected by the controller may be based on desired performance characteristics. In one example, the characteristics could be defined by the vessel operator at the time of vessel operation. For example, the operator may indicate that during periods of steady state operation, combinations of settings are desired that are biased towards maximal propeller performance (rather than engine performance). The operator may similarly indicate that during periods of acceleration, combinations of settings are desired that are biased towards maximal engine performance (rather than propeller performance). Alternatively, the operator may indicate preferences for fuel economy versus rapid response time during the different operations. Further still, instead of being input by the operator, the preferences can be set as default settings in the propulsion system control program.

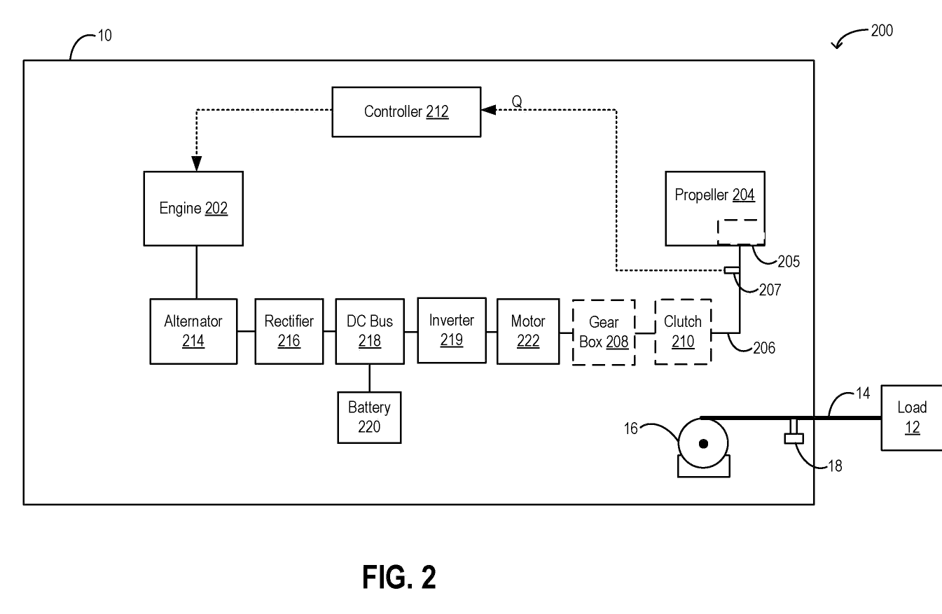

FIG. 2 describes another example embodiment 200 of a marine propulsion system housed in marine vessel 10. Herein, the marine propulsion system is configured with a series hybrid drive. As previously elaborated with reference to FIG. 1, marine vessel 10 could be a tugboat configured to tow and/or steer a load 12 using a towing cable 14 connected to towing winch 16 with towing eyelet 18 providing traction.

Marine vessel 10 can operate on a diesel engine 202. However, in alternate embodiments, alternate engine configurations may be employed, such as a gasoline engine, a turbine engine, or a biodiesel or natural gas engine, for example. Engine 202 generates a torque that is transmitted to propeller 204 along propeller shaft 206. In one example, propeller 204 may be a fixed pitch propeller (FPP), in which case no associated pitch controller may be required. Specifically, when using a FPP, the speed of motor 222 and the propeller speed may be varied together in a fixed ratio, such as the gear ratio. In another example, propeller 204 may be a controllable pitch propeller requiring an associated pitch controller 205. As previously illustrated, torsion meter 207 mounted on propeller shaft 206 provides a real-time estimate of propeller torque (Q) to controller 212. An alternator 214 is configured to generate an electric current from engine 202. The generated alternating current (AC) is then rectified by rectifier 216 to a direct current (DC), which can be transmitted along DC bus 218. At least a part of the current is stored as charge in battery 220 connected to DC bus 218. Alternatively, the current may be used to operate propeller 204 using motor 222. In one example, motor 222 may be an AC motor. Accordingly, the current from DC bus 218 may be inverted by inverter 219 before being transmitted to motor 222. A gear box 208 and a clutch 210 may be optionally provided along propeller shaft 206, specifically in between motor 222 and propeller 204, to enable torque modulation.

As previously elaborated, in response to a speed and/or power request, controller 212 adjusts engine settings, such as engine speed and/or engine torque independently from the propeller settings, such as propeller speed, based on real-time estimated vessel operating data, updated engine performance maps, and desired performance characteristics. By doing so, enhanced engine performance is enabled under the prevalent vessel operating conditions. Controller 212 may accordingly further adjust a propeller torque output.

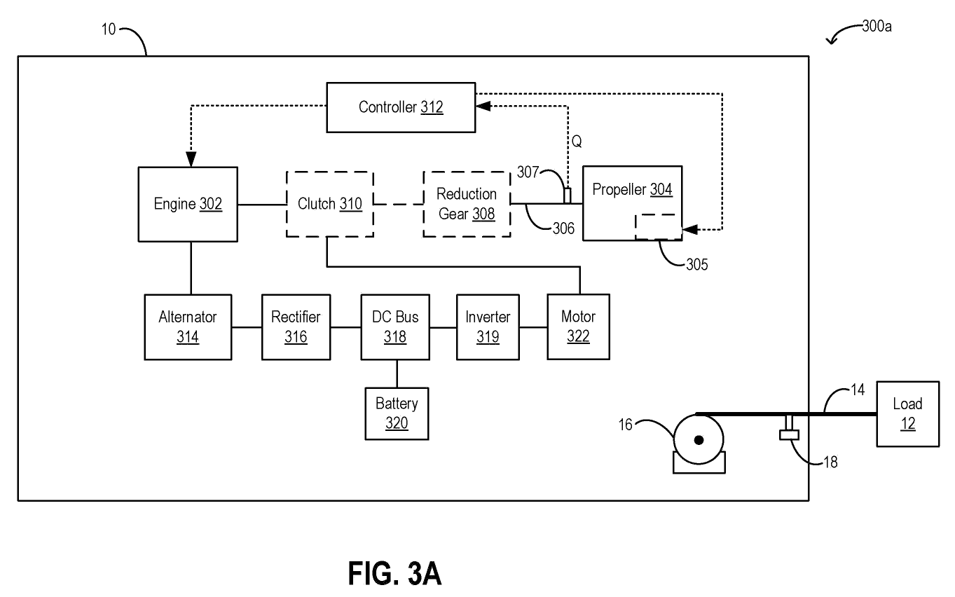

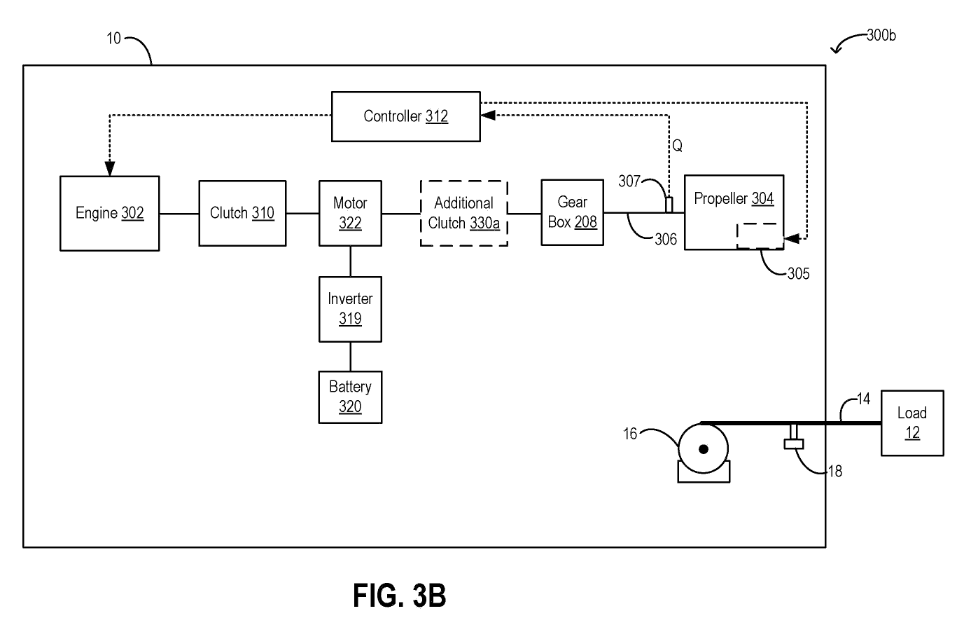

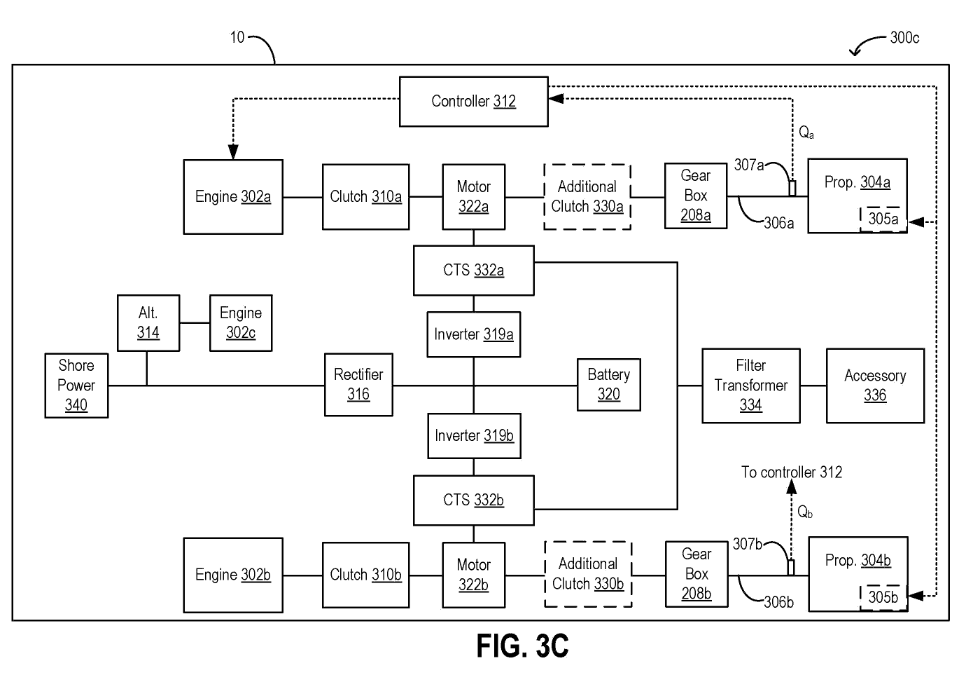

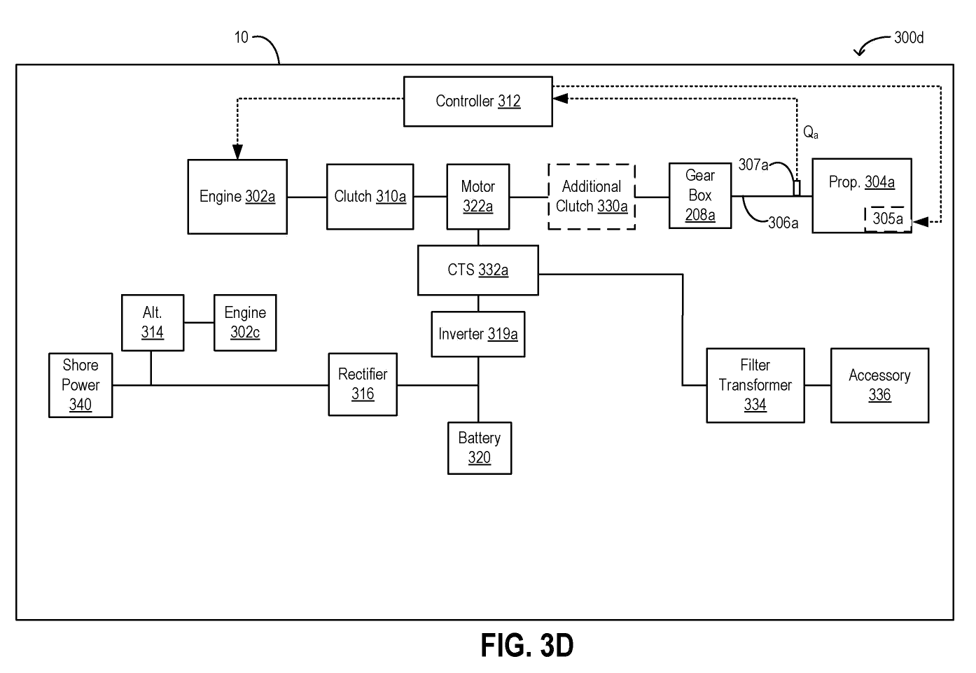

FIG. 3A describes another example embodiment 300a of a marine propulsion system housed in marine vessel 10. Herein, the marine propulsion system is configured with a parallel hybrid drive. As previously elaborated, marine vessel 10 may be a tugboat configured to tow and/or steer a load 12 using a towing cable 14 connected to towing winch 16 with towing eyelet 18 providing traction. In the depicted embodiment, the propulsion system includes a hybrid drive.

Marine vessel 10 can operate on a diesel engine 302. However, alternate engine configurations may be employed, such as a gasoline engine, a turbine engine, or a biodiesel or natural gas engine, for example. Engine 302 generates a torque that is transmitted to propeller 304 along propeller shaft 306. In the depicted example, propeller 304 can be a fixed pitch or a controllable pitch propeller. In one example, where propeller 304 is a fixed pitch propeller (FPP), no associated pitch controller may be required. Specifically, when using a FPP, the speed of motor 322 and the propeller speed may be varied together in a fixed ratio, such as the gear ratio. In another example, where propeller 304 is a controllable pitch propeller, an associated pitch controller 305 may be required. Torsion meter 307 mounted on propeller shaft 306 provides a real-time estimate of propeller torque (Q) to controller 312. Alternator 314 generates an electric current from engine 302. The generated alternating current (AC) is rectified by rectifier 316 to a direct current (DC), which is then transmitted along DC bus 318. At least a part of the current is stored as charge in battery 320 connected to DC bus 318. Alternatively, the current may be used to operate propeller 304 using motor 322. In one example, motor 322 may be an AC motor. Accordingly, the current from DC bus 318 may be inverted by inverter 319 before being transmitted to motor 222. A reduction gear 308 and a clutch 310 may optionally be provided along propeller shaft 306, specifically in between motor 322 and propeller 304, to enable torque modulation.

Herein, the alternator-motor combination enables engine and propeller performances to be decoupled so that they may be independently adjusted and optimized. In response to a speed and/or power request, controller 312 can independently adjust engine settings, such as engine speed and/or engine torque, to provide enhanced engine performance under the given vessel operating conditions. Specifically, engine torque is adjusted by receiving power from a battery during loaded operations, and using the engine to charge the battery during light loads. Similarly, propeller settings (such as pitch) are optimized based on performance maps updated using real-time vessel operating data. An optimization routine may also determine an optimal motor-generator to propeller power split based on the operating conditions, and/or the desired vessel performance characteristics.

FIG. 3B describes another example embodiment 300b of a marine propulsion system configured with a parallel hybrid drive. As previously elaborated, marine vessel 10 may be a tugboat configured to tow and/or steer a load 12 using a towing cable 14 connected to towing winch 16 with towing eyelet 18 providing traction. In the depicted embodiment, marine vessel 10 can operate on diesel engine 302. However, alternate engine configurations may be employed, such as a gasoline engine, a turbine engine, or a biodiesel or natural gas engine, for example. Engine 302 generates a torque that is transmitted to propeller 304 along propeller shaft 306. In the depicted example, propeller 304 can be a fixed pitch or a controllable pitch propeller. In one example, where propeller 304 is a fixed pitch propeller (FPP), no associated pitch controller may be required. Specifically, when using a FPP, the speed of motor 322 and the propeller speed may be varied together in a fixed ratio, such as the gear ratio. In another example, where propeller 304 is a controllable pitch propeller, an associated pitch controller 305 may be required. Torsion meter 307 mounted on propeller shaft 306 provides a real-time estimate of propeller torque (Q) to controller 312.

The torque output of engine 302 is transmitted to traction motor 322. As such, traction motor 322 may be a motor-generator. Clutch 310 positioned between engine 302 and motor 322 may enable the operation of motor 322 to be decoupled from the engine operation. In the depicted embodiment, an intermediate alternator and rectifier may not be required to transmit the torque generated at engine 302 to motor 322, although an alternator and/or a rectifier may be added if desired. If present, the alternator may generate an alternating electric current from the engine, which may then be rectified by the rectifier before transmission to traction motor 322. At least a part of the current may be stored as charge in battery 320. Battery 320 may be charged or discharged via inverter 319. Alternatively, the current may be used to operate propeller 304 using motor 322. A gear box 208, and an optional additional clutch 330a may be provided along propeller shaft 306, specifically in between motor 322 and propeller 304. Optional additional clutch 330a enables propeller 304 to be disengaged from motor 322. In one example, by decoupling propeller 304 from motor 322, the motor may be used to crank engine 302 at engine restart. The charge stored in battery 320 may be used, when needed, to supplement the power output by motor 322 and the performance of propeller 304. Alternatively, in case of engine 302 degradation, battery 320 may be used to provide the power required to operate motor 322 and consequently propeller 304. In one example, motor 322 may be an AC motor. Accordingly, the current from battery 320 may be inverted by inverter 319 before being transmitted to motor 322. The depicted embodiment enables system reliability to be improved (for example, by enhancing the robustness to engine degradation and/or inverter degradation) without the need for additional system components (or example, without necessitating an alternator, an alternator field controller and/or a rectifier). That is, fewer system components may be used to achieve hybrid drive benefits.

FIG. 3C describes yet another example embodiment 300c of a marine propulsion system configured with a parallel hybrid drive. As previously elaborated, marine vessel 10 may be a tugboat configured to tow and/or steer a load. In the depicted embodiment, marine vessel 10 can operate on a plurality of engines, such as a first engine 302a and a second engine 302b. In one example, the plurality of engines may be located on different sides of the marine vessel. For example, first engine 302a may be a starboard-side-located diesel engine while second engine 302b may be a port-side-located diesel engine. In alternate embodiments, any or both of engines 302a and 302b may have an alternate configuration, such as a gasoline engine, a turbine engine, or a biodiesel or natural gas engine, for example.

First and second engines 302a and 302b generate a torque that is transmitted to first and second propellers 304a and 304b along first and second propeller shafts 306a and 306b, respectively. In the depicted example, propellers 304a and 304b can be fixed pitch or controllable pitch propellers. In one example, where propellers 304a and/or 304b are fixed pitch propellers (FPP), no associated pitch controller may be required. Specifically, when using a FPP, the speed of traction motors 322a and 322b, and the propeller speeds, may be varied together in a fixed ratio, such as the gear ratio. In another example, where propellers 304a and/or 304b are controllable pitch propellers, a propeller-associated pitch controller, 305a and/or 305b respectively, may be required. Torsion meters 307a and 307b mounted on propeller shafts 306a and 306b respectively may provide a real-time estimate of respective propeller torque (Qa and Qb) to controller 312.

A first and a second electric machine may be selectively coupled to the first and second engines, respectively. In one example, the first and second electric machines may be a first and second traction motor 322a and 322b, respectively. The torque output of engines 302a and 302b may be transmitted to traction motors 322a and 322b respectively. As such, traction motors 322a and 322b may be motor-generators. That is, based on engine operating conditions, traction motors 322a and 322b may be used for transmitting torque from the engine to the respective propellers, or may be used for generating electricity that may be stored in a battery. Clutch 310a positioned between engine 302a and motor 322a, and clutch 310b positioned between engine 302b and motor 322b, may enable the traction motors to be decoupled from their respective engines. In doing so, the torque input into the respective propellers may be modulated. In the depicted embodiment, an intermediate alternator and rectifier may not be required to transmit the torque generated at each engine, although an alternator and/or a rectifier may be added if desired. If present, the alternator may generate an alternating electric current from the engine, which may then be rectified by the rectifier before transmission to the respective traction motor.

The first and second electric machines may be further mechanically coupled to the first and second propeller shafts 306a and 306b of first and second propellers 304a and 304b, respectively. The engine outputs may be used by the respective traction motors to operate the respective propellers. A gear box 208a or 208b, and an optional additional clutch 330a or 330b may be provided along propeller shafts 306a and 306b, specifically in between motor 322a and propeller 304a or motor 322b and propeller 304b. Optional additional clutch 330a and 330b enables propellers 304a and 304b to be disengaged from motors 322a and 322b respectively. In one example, where motors 322a and 322b are electric motors, by decoupling the propellers from the respective motors, one or more of the electric motors may be used to crank one or more of the engines at engine restart.

At least a part of the current generated by the engine(s) may be stored as charge in battery 320. Battery 320 may be coupled to each of the first and second electric machines, for example, each of traction motor 322a and 322b, through an electrical power distribution system. The electrical power distribution system may enable battery 320 to be charged by (first) engine 302a through the use of motor 322a. Additionally, or optionally, battery 320 may be charged by (second) engine 302b through the use of motor 322b. As further elaborated herein, the charge stored in battery 320 may be used, when needed, to supplement the power output by motors 322a and/or 322b and the performances of propellers 304a and/or 304b. Alternatively, in case of (first) engine 302a and/or (second) engine 302b degradation, battery 320 may be used to supplement the power required to operate the traction motors and consequently the propellers. In one example, as depicted, motors 322a and 322b may be AC motors. Accordingly, the current from battery 320 may be inverted by inverters 319a and 319b before being transmitted to motors 322a and 322b.

The output from one or both of traction motors 322a and 322b may also be used to operate accessory 336 load components, such as cabin lights, heating and/or cooling systems, on-board diagnostics, etc. Inverters 319a and 319b may be operatively coupled to respective crank transfer switches (CTS) 332a and/or 332b. CTS 332a and 332b may enable the respective inverters to be connected either to the respective motors 322a and 322b or to filter transformer 334. Filter transformer 334 may be positioned upstream of the accessory 336 components to enable current of a suitable waveform to be transmitted to the accessory 336 components for their operation. For example, filter transformer 334 may enable a square waveform of current to be converted to a sinusoidal waveform, for transmission to accessory 336 components. In one example, the first and second engines may be propulsion engines. Herein, propulsion engine refers to a main engine used primarily for propulsion. However, under conditions of low load engine operation, the propulsion engine can also be used to generate electricity that is stored in the battery. As such, the propulsion engines may be operated at different settings. Accordingly, the above-listed components connected to, and including, the propulsion engines may embody a propulsion circuit of the propulsion system. Further, during low load conditions (particularly substantially below peak engine output, e.g., less than half of peak engine output), the propulsion engines can be adjusted to provide the average vessel power, with transient increases/decreases in desired output provided by adjusting the electric motor/generates coupled to the propellers.

The second engine of marine propulsion system 300c may additionally or optionally be an auxiliary engine 302c. Herein, in contrast to the propulsion engine, the auxiliary engine refers to an engine that may be smaller (though this may not be necessary) and is used primarily for running accessory loads. Furthermore, the auxiliary engine may be operated continuously at a constant setting (e.g. 60 Hz). However, as elaborated herein, under propulsion engine degradation conditions, the auxiliary engine can be used, at least in part, to propel one or more of the propellers. As such, the auxiliary engine may not be mechanically coupled to a propeller. The second (auxiliary) engine may, however, be selectively mechanically coupled to a second electric machine, herein alternator 314. While the depicted embodiment shows engine 302c as an auxiliary diesel engine, it will be appreciated that engine 302c may have alternate configurations, such as a turbine engine, a biodiesel, gasoline, or natural gas engine. Auxiliary engine 302a may be run at a fixed setting, such as at 60 Hz. Auxiliary engine 302c may be operated (for example, continually operated) at the fixed setting to provide power for the operation of accessory 336 loads and components. For example, the power generated by auxiliary engine 302c may be used to operate cabin lights, on-board controls, cabin heating, cabin cooling, cabin ventilation, etc. Additionally, auxiliary enging 302c may be configured to operate under conditions of degraded propulsion engine (that is, engine 302a and/or 302b) performance. Alternator 314 may generate an alternating electric current from the rotation of engine 302c, which may then be rectified by rectifier 316 before transmission. In one example, rectifier 316 may be a phase control rectifier configured to transfer power between the auxiliary engine 302c and battery 320. During periods of auxiliary engine low load operation, for example when there is a reduced demand for cabin heating or cooling, or when the accessory 336 load is low, the auxiliary engine 302c may be configured to charge battery 320 in addition to operating the accessory 336 load. Thus, under conditions where battery 320 were being used to supplement or substitute the power output of a propulsion engine, the continuous trickle charging of battery 320 by the continuous operation of auxiliary engine 302c may enable the battery to be depleted at a slower rate. Battery 320 may be coupled to alternator 314 through the electrical power distribution system, thereby enabling at least a part of the current generated by engine 302c to be stored as charge in battery 320. Alternatively, the current may be used to operate any or both of motors 322a and 322b, and consequently propellers 304a and/or 304b. In one example, when the second engine is an auxiliary engine, the components connected to, and including, the auxiliary engine may embody an auxiliary circuit of the propulsion system. In the event of degradation of auxiliary engine 302c, the accessory 336 load of the auxiliary circuit may be at least partially borne by battery 320 and/or one or more of the propulsion engines 302a and 302b. Specifically, power may be transferred from battery 320 and/or one or more of the propulsion engines 302a and 302b to accessory 336 load through the inverter, CTS, and filter transformer. This may enable the propulsion system to continue operation of the marine vessel even in the presence of engine degradation.

When marine vessel 10 is docked at the shore, a shore power source 340 may be used, in lieu of operating engines 302a-c, to charge battery 320 and/or run accessory load components 336. The incorporation of battery 320 in the depicted configuration enables the performance characteristics of the propulsion system to be adaptively reconfigured in response to transient changes in power demand and/or load. A controller 312 may have code therein, the technical effect of which may include the dynamic adjustment of propulsion system operation responsive to vessel operating conditions. These may include conditions of the electrical and mechanical components, such as the engines, propellers, motors, etc. As such, the electrical configuration depicted enables power to be transferred in various directions, for example, in either direction between a propulsion circuit and an auxiliary circuit. As further elaborated herein, the controller may dynamically adjust operation of the propulsion system by selectively increasing and/or decreasing propeller torque output (for example, of the first propeller) by increasing and/or decreasing torque generation and/or absorption by the electric machine coupled to the propeller (for example, the first electric machine). In this way, a multi-redundant power solution for the marine vessel is enabled. Furthermore, the depicted electrical configuration allows system reliability to be increased without necessitating an increase in the number of system components.

In one example, during a transient increase in load, the throttle response to the step load increase may be improved by supplementing the diesel engine shaft torque of the engines 302a and 302b (also, optionally, 302c) with motor electrical torque delivered from the battery. The battery may also enable the diesel engine performance to be boosted during the high transient load demand. In another example, in the event of degradation of one of engines 302a or 302b, the performance of the respective propeller may be maintained by transferring power from the other engine, the auxiliary engine, and/or the battery. Similarly, in the event of degradation of both engines 302a and 302b, the performance of the propellers in the propulsion circuit may be maintained by transferring power from the auxiliary engine and/or the battery. It thus follows that an extensive degradation of propulsion system performance may occur in the rare event of triple engine degradation (that is, degradation of propulsion engines 302a and 302b, and auxiliary engine 302c) and low battery charge (that is, battery charge being depleted to below a threshold, such that the battery may not be able to support propeller performance). In still another example, the marine vessel may be operated in an emission-free mode by operating the propulsion system entirely off the battery, until the battery charge is at or below a threshold beyond which battery recharging is required.

As such, the battery may be configured to both accept and deliver power from the propulsion system. Specifically, the battery may be capable of accepting and delivering power from the shore power source, either of the two inverters operatively coupled to the diesel engines 302a and 302b, and/or the rectifier coupled to the auxiliary engine 302c. Additionally, the battery may accept power from a dedicated diesel generator (not shown) coupled to the propulsion system. Further still, during a hybrid charging mode, the battery may be charged by the passing of water over the propellers. As further elaborated with reference to FIG. 6, by enabling a flexible and reconfigurable propulsion system by the incorporation of a battery, the existing prime movers may be used to provide a high efficiency, low emissions propulsion system capable of responding rapidly and efficiently to load changes. In doing so, the reliability of a marine vessel propulsion system may be made enhanced without substantially increasing component redundancy. On the contrary, the number of engines needed to elicit an improved performance may be reduced.

FIG. 3D illustrates another example embodiment 300d of a marine propulsion system configured with a parallel hybrid drive. As such, embodiment 300d may be substantially similar to the embodiment of 300c, however, the embodiment of FIG. 3D may include a single propulsion engine 302a coupled to a single propeller 304a and an auxiliary engine 302c configured to operate the vessel's accessory 336 load. As such, all other components included in the embodiment of FIG. 3D may be included, and may be named and numbered as in FIG. 3C. The similarly named and numbered components are not re-introduced herein for reasons of brevity.

Different variables may have substantially different effects on the movement of a point in a propeller and/or engine performance map. As such, a point on a propeller performance map may be mapped as a function of propeller torque, propeller rotational speed, and propeller speed of advance in water. Similarly, a point on an engine performance map may be mapped as a function of engine torque, and engine speed. A controller may be configured to optimize the operationally controllable variables to thereby maximize the efficiency of the engine and propeller.

In one example, a speed reference may be provided to the controller when towing a load or facing a headwind. Consequently, a propeller speed of advance may decrease. The decrease in the propeller speed of advance may shift the propeller's performance point on the propeller performance map. To resist, or counter the shift, and return the propeller to the original performance point on the propeller performance map, an increase in propeller torque may be required. However, the increased propeller torque may cause an increase in the engine torque by increasing fuel consumption while holding engine speed constant (due to the speed reference). As a result, engine performance may degrade. Herein, the controller may optimize engine and propeller performances by adjusting the propeller torque through pitch adjustments, that is, adjusting a single variable. Alternatively, the optimization routine may independently adjust a plurality of variables, such as engine and propeller speed and torque. This may be possible by maintaining substantially constant propulsion system power (that is, using a power reference), or by using an energy storage device in the system, such as a battery.

In another example, a power reference may be provided to the controller when towing a load or facing a headwind. As previously elaborated, the consequent decrease in propeller speed of advance may result in an increase in propeller torque to return the propeller to the original point on the performance map. Once a change in torque is sufficiently defined, the controller may calculate an optimum efficiency combination of propeller torque and speed, inferring propeller speed of advance as needed from design and/or trial data, and a real-time estimate of propeller torque (for example, from the shaft-mounted torsion meter). The optimal combination of propeller and engine efficiency may be determined by constructing a combined efficiency map including allowable values of propeller speed and torque that may provide the requested power.

While the examples above illustrate the effect of changes in propeller speed of advance and propeller torque on the performance point of a propeller on a performance map, it will be appreciated that, in the same way, alternate variables may affect the performance point on engine and propeller performance maps either independently or simultaneously, each with their own relationship on efficiency.

Thus, as indicated, differing variables may have substantially differing effects on the same propulsion system component (such as, the differing effect of pitch versus torque on propeller performance), and further still, may have substantially differing effects on differing propulsion system components (such as, the differing effect of torque on propeller versus engine performance). Further still, significant inaccuracies can creep into the engine and propeller performance maps when the operating conditions used as the variables are estimated and/or inferred from model-tested data and/or theoretical calculations. Thus, by using real-time vessel operating data, data that accurately and more reliably represents prevalent vessel operating conditions, and by using the real-time estimated data to update pilot engine and propeller performance maps, the actual effect of the combination of variables on engine and propeller performances can be more precisely determined. By using such updated performance maps, the controller may perform a multi-variable optimization routine, such as those depicted in FIGS. 4-5, to better enable propeller and engine performances to be suitably matched during the operation of a vessel configured with a propulsion system. By supplying a propulsion control program with a better knowledge of the optimal operating conditions of the prime movers across the entire range of operation, and by updating the optimal operating conditions in real-time, the efficiency of the propulsion system may be significantly improved.

Real-time vessel operating data may include real-time estimates of actual propeller torque, as determined by the propeller shaft mounted torsion meter. The real-time vessel operating data may further include an engine speed, a vessel speed of advance, a vessel sea load, a vessel wind load, an estimate of tidal currents, and the like. Propeller curves developed from model data and/or pilot vessel settings, may accordingly be updated. In one example, pilot propeller curves may be mapped based on propeller rotational speed, pitch, and speed of advance. Model data regarding speed of advance may be estimated from vessel speed and wake effects. However, vessel speed as anticipated based on design conditions may vary significantly from actual vessel speeds. Estimates from speed of advance sensors mounted on a vessel's hull may also suffer from inaccuracies due to exposure to harsh and variable conditions. Since propeller torque and speed of advance are directly related, an accurate estimate of the speed of advance may be achieved based on the accurate real-time estimate of propeller torque from the torsion meter. That is, the vessel speed of advance may be estimated responsive to the propeller torque and the updated performance maps. Based on contours of propeller efficiency in the updated map, the multivariable optimization routine may select a new propeller pitch setting that allows propeller performance to be maximized under the updated operating conditions. Independently, engine performance maps, such an engine fuel map, may be updated in real-time based on the real-time vessel operating data. An optimal combination of engine speed and engine torque capable of providing the desired power may subsequently be selected, based on the updated maps. In this way, a real-time estimate of vessel speed, as inferred from propeller torque, may be used to optimize propeller and engine settings for a desired power output such that the operation efficiency of a propulsion system may be enhanced. Additional details of such control system operations are described below with reference to FIGS. 4-5.

Now turning to FIG. 4, a routine 400 for optimizing the settings of a propulsion system in real-time, responsive to changes in operating conditions, is described. The routine may be performed in response to an operator request. The operator request may be provided as a speed or power reference. In one example, the speed or power reference may then be translated into a requested torque. Upon determining the operating conditions, and based upon the operator request, a propeller pitch, propeller speed, engine speed, battery state of charge, and other related controllable variables may be mapped and adjusted.

At 402, a propeller torque (Q) is determined. In one example, a real-time estimate of propeller torque is determined based on a torsion meter located on the propeller shaft. At 404, real-time vessel operating data may be determined. These may include estimations of operating conditions of components internal to the vessel, such as engine and propeller settings, as well as external influences. As one example, this may include determining engine speed, engine load, engine power output, propeller pitch, propeller rotational speed, battery state of charge (in hybrid systems) etc. Further, determining external influences may include, for example, estimating wind load, towing load, hull fouling, sea load, tidal currents, the like, and changes in vessel displacement due to a combination of these influences. At 406, the speed of advance of the vessel (Va) is determined. As such, a global positioning system (GPS) may be used to determine the speed of the vessel. However, it may be appreciated that this may not give an exact value of Va since the actual speed of advance of the vessel in water can be significantly affected by the state of tidal currents, wind loads, sea loads, etc. Thus, in one example, Va can be determined computationally based on the determined engine load, pitch, engine speed, and torque.

At 408, the real-time vessel operating data is used to update engine and propeller performance points and curves. As such, each engine and propeller may have individual performance maps based on their make and model. Based on the mapped data and the computed speed of advance, engine settings, such as an engine output (that is engine speed and/or engine power), and propeller settings, such as a propeller pitch, may be independently adjusted to enable the overall efficiency of the propulsion system to be optimized.

In one example, an engine speed may be adjusted responsive to the updated engine setting and a propeller pitch may be adjusted responsive to the updated propeller setting, the engine speed adjusted independently from propeller pitch. In another example, an engine speed may be adjusted responsive to the engine setting while a propeller torque may be adjusted responsive to the propeller setting, the engine speed adjusted independently from propeller torque. In yet another example, an engine torque may be adjusted responsive to the engine setting while a propeller torque is adjusted responsive to the propeller setting, the engine torque adjusted independently from the propeller torque.

In this way, the settings of an engine and propeller of a propulsion system are adjusted responsive to a high degree of variability of vessel operating conditions to provide a combination that imparts higher efficiency to the system. As elaborated with reference to FIG. 6, the multi-variable optimization routine can further adjust engine and propeller settings based on a vessel mode of operation (for example, steady state versus acceleration) and an indicated or predetermined preference for certain performance characteristics, for example, enhanced fuel efficiency or maximal propeller performance during steady state and rapid response times or maximal engine performance during accelerations.

Now turning to FIG. 5, an example real-time optimization routine 500 is described. At 502, real-time vessel operating data is collected. These include estimations of internal conditions such as engine speed (Nₑ), propeller pitch (P), torque, and external influences such as wind load, towing load, hull fouling, sea load, tidal currents, and the like. At 504, the vessel speed of advance (Vₐ) are calculated computationally based, at least on, the determined engine speed, propeller pitch, and torque. At 506, it is confirmed whether the vessel is in a steady state mode of operation. If yes, then at 510, a multivariable optimization is performed to compute new settings for engine speed, propeller pitch, and torque output based on the conditions estimated at 502-504. Data smoothing techniques can be used to avoid excessive speed and torque changes during the optimization process. A power setting reference, such as a power range, can be selected and the multivariable optimization then computes optimized speed, pitch and torque settings while keeping power constant within the defined power range. In alternate embodiments, a speed of advance reference can be selected and the settings may be adjusted to allow the speed of the engine and propeller to remain constant, or within a predefined range.

At 512, the new settings are mapped onto updated engine and propeller performance maps to determine propeller performance efficiency, engine fuel efficiency, and a net efficiency, when combined. In one example, during steady state operation, it may be desirable to bias the net efficiency towards propeller performance. Accordingly, at 514, it is confirmed whether the combination of settings selected enable a net efficiency towards enhanced (for example, maximal) propeller performance. If yes, then at 518, the new settings are applied. If not, then at 516, the routine performs a new iteration of the multivariable optimization routine to identify a new combination of settings that better enable propeller performance to be improved.

If at 506, a steady state operation is not confirmed, then at 508, an acceleration mode of operation is confirmed at 508. At 520, as at 510, a multivariable optimization routine is performed to compute new settings for engine speed, propeller pitch, and torque output based on the conditions estimated at 502-504. Data smoothing techniques are used to avoid excessive speed and torque changes during the optimization process. A power setting, or a speed setting, is selected, based on the power and/or speed requested, and the multivariable optimization accordingly computes optimized speed, pitch and torque settings while keeping the power constant within the defined power range, or while maintaining the speed constant, or within a defined speed range.

At 522, the new settings are mapped onto updated engine and propeller performance maps to determine propeller performance efficiency, engine fuel efficiency, and a net efficiency, when combined. In one example, during accelerated operation, it may be desirable to bias the net efficiency towards engine performance. It may be further determined whether the bias towards engine performance is desired with improved fuel savings or improved response times. As one example, if improved fuel savings are desired, a combination of settings corresponding to the lowest specific fuel consumption may be selected. As another example, if improved response time is desired, settings corresponding to the most rapid response time may be selected. A controller may choose between the alternatives based on, for example, the rate of change commanded, or the magnitude of change commanded. At 524, it is confirmed whether the net efficiency is towards the enhanced engine performance. If yes, then at 518, the new settings are applied. If not, then at 526, the routine performs a new iteration of the multi-variable optimization routine to identify new settings that enables a shorter response time.

While the depicted example illustrates a routine wherein engine performance is desirable during accelerations and propeller performance is desirable during steady state operations, in alternate embodiments, the multivariable routine may be adjusted based on alternate preferences. These preferences may be indicated to the controller by an operator, or may reflect default preferences. Thus, in another example, during steady state operation, a combination of engine and propeller settings may be chosen that enables enhanced fuel savings while during acceleration, the settings may be readjusted to enable enhanced response times.

Adjustments to each of an engine setting and a propeller setting may include, adjustments to engine speed while adjusting propeller pitch, adjustments to engine speed while adjusting propeller rotation speed, and/or adjustments to engine torque and propeller torque. In one example, the adjustments may include, increasing an engine speed while maintaining a propeller pitch. In another example, the adjustments may include, increasing a propeller pitch while maintaining engine speed. In yet another example, a propeller pitch may be increased while engine speed is decreased, or an engine speed may be increased while decreasing a propeller pitch. It will be appreciated that all other combinations may also be possible. Furthermore, one or more of the adjustments may be performed in immediate or non-immediate succession as needed. In one example, the adjustment may include increasing the engine speed while increasing the propeller pitch, following which (for example, after a lag time), the adjustment may include increasing the engine speed while maintaining the propeller pitch. In another example, the adjustment may include decreasing the engine speed while decreasing the propeller pitch, following which the engine speed may be increased while decreasing the propeller pitch, following which the engine speed may be decreased while maintaining the propeller pitch. It will be appreciated that all other combinations may also be possible with one or more steps in each adjustment, and with different time lags between the different steps.

In this way, the engine and propeller settings of a propulsion system can be dynamically reconfigured, in real-time, in response to real-time vessel operating data. By updating engine and propeller performance maps using real-time vessel operating data, data representative of the real-time changes in vessel operating conditions, reliable and accurate maps can be generated that do not suffer from the inaccuracies of maps based on model-tested data. By using such accurate maps, and further based on vessel performance characteristics desired, engine and propeller settings may be independently reconfigured. In doing so, the engine and the propeller can each be independently configured to perform maximally. Furthermore, the performance of the engine and the propeller can be better matched, thereby improving the overall efficiency of the propulsion system.

Now turning to FIG. 6, an example reconfiguration routine 600 is described. The reconfiguration routine enables the propulsion system to be flexible, and to respond rapidly and efficiently to load changes. A controller included in the propulsion system may be configured to perform such a routine to dynamically adjust the operation of the propulsion system responsive to vessel operating conditions. At 602, the operating conditions of the propulsion system may be determined. For example, it may be determined whether the propulsion system is experiencing a transient change in load. If so, it may be further determined whether the transient change in load is equally distributed between system engines or whether the transient load change is being primarily experienced by a specific engine. Similarly, it may be determined whether the transient change in load is distributed symmetrically or asymmetrically between the system propellers. In another example, it may be determined whether any engine and/or propeller degradation has occurred. In still another example, the state of charge of the system battery may be determined.

At 604, based on the determined operating conditions, an operating mode may be selected. Accordingly, at 606, the propulsion system may be operated in the selected operating mode. In one example, when the load is distributed between the first and second engines, and further the battery state of charge is above a threshold, the propulsion system may be operated in a first mode wherein both the first and second engines may be used to power the first and second propellers, respectively, without charging the battery. Herein, since the battery is well charged, if needed, the battery may be additionally used to supplement the power output by the first and/or second engine to operate the first and/or second propeller. In another example, when the load is distributed between the first and second engines, and further the battery state of charge is at or below a threshold, the propulsion system may be operated in a second mode wherein both the first and second engines may be used to power the first and second propellers, respectively, without discharging the battery for propulsion. Herein, the battery charge may be prevented from further discharge. Alternatively, the battery state of charge may be at or above the threshold, and the battery may not be discharged to conserve the battery charge for use at a later time, for example, at a time when the engine power needs to be supplemented.

In yet another example, when a battery charging opportunity arises, for example, when the vessel is slowing down, the propulsion system may be operated in a third mode wherein both the first and second engines may be used to power the first and second propellers, respectively, and further the battery may be charged by power received from at least one of the first and second electric machines (that is, motor-generators). Herein, the extra power generated by the engines that is not needed to operate the propellers may be stored as charge in the battery, for use at a future time. In another example, when a transient load surge is experienced by one or more of the engines, the propulsion system may be operated in a fourth mode wherein both the first and second engines may be used to power the first and second propellers, respectively, and further torque may be generated in at least one of the first and second motor-generators through the battery. Herein, the throttle response to the step load increase may be improved by supplementing the torque of the first and/or second engines with torque from the battery.

In another example, when a transient load drop is experienced, the propulsion system may be operated in a fifth mode wherein only the first engine may be used to power at least both of the first and second propellers by operating at least the second electric machine and power may be transferred from the first engine to the second motor-generator through the first motor-generator and the electrical power distribution system. Herein, the torque output of a single engine (for example, only the first engine) may suffice to power both the first and second propellers. Thus, the first engine may power the two propellers by operating both of the motors coupled to the propellers. As such, this may provide fuel economy benefits. Alternatively, the propulsion system may be operated in the fifth mode responsive to degradation in the second engine. Herein, the power distribution may be reconfigured to enable the torque output of the first engine to compensate for the loss of torque from the second engine. It will be appreciated that in an alternate embodiment of the fifth mode, responsive to degradation of the first engine, the second engine may power the two propellers by operating both of the motors coupled to the propellers. In this way, both propellers may continue to be operated and the performance of the vessel may not be adversely affected.

In still another example, when a transient load drop is experienced or degradation of the second engine is determined, and further a battery charging opportunity arises (for example, due to the vessel slowing down), the propulsion system may be operated in a sixth mode wherein only the first engine may be used to power at least both of the first and second propellers by operating at least the second electric machine, and power may be transferred from the first engine to the second motor-generator through the first motor-generator and the electrical power distribution system, and additionally, the battery may be charged. Herein, as in the fifth mode, the torque output of one engine may be advantageously used to operate two propellers to reduce a drop in vessel performance. Additionally, the battery may be advantageously charged with any extra power generated by the engine, and the charge may be stored for later use. It will be appreciated that in an alternate embodiment of the sixth mode, responsive to degradation of the first engine, the second engine may power the two propellers by operating both of the motors coupled to the propellers, while charging the battery.

In yet another example, when degradation in the second engine is determined, and the torque output of the first engine may not suffice to power both propellers, the propulsion system may be operated in a seventh mode wherein only the first engine may be used to power at least both of the first and second propellers by operating at least the second motor-generator, and transferring power from the first engine to the second motor-generator through the first motor-generator and the electrical power distribution system, and additionally, the battery may be discharged to supplement the engine output of the first engine. In this way, the battery output may be advantageously used to boost the output of the first engine. It will be appreciated that in an alternate embodiment of the seventh mode, responsive to degradation of the first engine, the second engine may power the two propellers, and the torque output of the second engine may be supplemented by the battery output. In still another example, responsive to degradation in both the first and second engines, the propulsion system may be operated in an eighth mode wherein at least one of the first and second propellers may be operated with at least a respective one of the first and second motor-generators, and wherein the battery may provide power to the respective at least one motor-generator. Furthermore, both the first and second engines may be shutdown. Herein, the battery output may be used to at least partially compensate for a loss in power from the engines, thereby enabling the operation of the propeller(s) to be maintained. In doing so, the overall performance of the vessel may be maintained. In another example, the propulsion system may be operated in the eighth mode when it is determined that the vessel is to be operated in an emission-free mode. Herein, since the engines are shut down, all operations of the propulsion system may be powered off the battery, until the battery charge falls below a threshold beyond which battery recharging may be required.

In another example, the propulsion system may be operated in a ninth mode wherein the auxiliary engine is used to only power an accessory load by operating at least the alternator and transferring power from the alternator to the accessory load through the alternator and the electrical power distribution system. Herein, alongside, the first or second propulsion engine may be operated to power at least both of the first and second propellers. In this way, the propulsion engine may be used to power a propulsion circuit while the auxiliary engine may be used to power an auxiliary circuit. In yet another example, when the engines are operating at low loads, the propulsion system may be operated in a tenth mode wherein the auxiliary engine is used to power the accessory load (that is, power the accessory circuit) and further charge the battery, while operating the first (or second) engine to power at least both of the first and second propellers. Herein, by trickle-charging the battery, the charge depletion rate of the battery may be reduced. In still another example, when degradation in the auxiliary engine is determined, the propulsion system may be operated in an eleventh mode wherein the first (or second) engine is operated to power at least both of the first and second propellers and the accessory load, and further the battery is discharged to power the accessory load. In this way, by reconfiguring power between the propulsion and auxiliary circuits, the operation of the accessory loads may be continued.

It will be appreciated that when dynamically adjusting the propulsion system settings, a controller may be configured to operate the propulsion system in one or more of the plurality of modes described above. As such, the plurality of modes may be performed in immediate or non-immediate succession, as needed, with suitable time lags between successive modes. In one example, the adjustment may include operating the propulsion system in the fifth mode (with one engine powering both propellers) until a charging opportunity arises, at which time, the propulsion system may be shifted to the sixth mode (wherein the battery may be additionally charged). In another example, the propulsion system may be operated in the third mode (wherein the battery is charged) until engine degradation is determined, responsive to which, the propulsion system may be shifted to the seventh mode (wherein the charge stored in the battery may be used to compensate for power drops due to engine degradation). It will be appreciated that all other combinations may also be possible with one or more modes in each adjustment, and with different time lags between the different modes.

In this way, a flexible and reconfigurable propulsion system may be enabled wherein power may be transferred between system components as needed. By incorporating a battery into the propulsion system, electrical torque from the battery may be used to supplement and/or substitute diesel engine shaft torque from one or more of the system engines. Furthermore, a method for controlling the propulsion system of the vessel including one or more engines and one or more propellers may be enabled by reconfiguring the power distribution between one of the one or more engines and the battery responsive to vessel operating conditions, such as transient changes in engine load and/or engine degradation. By increasing power transfer from the battery to the engine or increasing power transfer from the engine to the battery, such transient changes in engine load and/or engine degradation conditions can be compensated for, without affecting the overall performance of the vessel. In this way, the system configuration improves system reliability and redundancy while reducing the number of system components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of controlling a propulsion system of a vessel including an engine and a propeller, the method comprising,
independently adjusting each of an engine setting and a propeller setting responsive to real-time vessel operating data, wherein the engine setting includes at least an engine speed setting, and wherein the propeller setting includes at least a propeller pitch setting.

2. The method of claim 1 wherein real-time vessel operating data includes propeller torque, engine speed, propeller speed, vessel sea load, and vessel wind load.

3. The method of claim 2 wherein propeller torque is estimated by a propeller shaft-mounted torsion meter.

4. The method of claim 3 wherein independently adjusting engine and propeller settings responsive to real-time vessel operating data includes updating at least an engine performance map and a propeller performance map based on the real-time vessel operating data, and then adjusting the engine setting and the propeller setting based on the updated engine performance map and the updated propeller performance map, respectively.

5. The method of claim 4 wherein real-time vessel operating data further includes a propeller speed of advance, and wherein the propeller speed of advance is estimated based on at least the updated performance maps and propeller torque.

6. The method of claim 5 further comprising, biasing adjustments to engine and propeller settings responsive to a vessel mode of operation.

7. The method of claim 6 wherein,
during a steady state mode of vessel operation, engine and propeller settings are independently adjusted to be biased towards improving propeller performance; and
during vessel acceleration, engine and propeller settings are independently adjusted to be biased towards improving engine performance.

8. The method of claim 1 wherein the propulsion system is a marine propulsion system and the vessel is a tugboat.

9. The method of claim 1 further comprising adjusting engine speed responsive to the engine setting and adjusting propeller pitch responsive to the propeller setting, the engine speed adjusted independently from propeller pitch.

10. The method of claim 1 further comprising adjusting engine speed responsive to the engine setting and adjusting propeller torque responsive to the propeller setting, the engine speed adjusted independently from propeller torque.

11. The method of claim 1 further comprising adjusting engine speed responsive to the engine setting and adjusting propeller speed responsive to the propeller setting, the engine speed adjusted independently from propeller speed.

12. A propulsion system, comprising:
an engine;
a propeller having a propeller shaft;
a torsion meter mounted on the propeller shaft; and
a control system having computer readable storage medium with code therein, the code configured to independently adjust each of an engine setting and a propeller setting, including at least an engine speed setting and a propeller pitch setting, responsive to real-time vessel operating data, including output data of the torsion meter.

13. The system of claim 12 wherein real-time vessel operating data includes a propeller torque, as estimated by the torsion meter, wherein independently adjusting engine and propeller settings responsive to real-time vessel operating data includes updating at least an engine performance map and a propeller performance map based on the real-time vessel operating data, and then adjusting the engine setting and the propeller setting based on the updated engine performance map and the updated propeller performance map, respectively.

14. The system of claim 13 wherein real-time vessel operating data further includes a propeller speed of advance, and wherein the propeller speed of advance is estimated based on at least the updated performance map and the propeller torque.

15. A method of controlling a marine propulsion system of a vessel including an engine and a propeller, the method comprising,
adjusting an engine setting responsive to real-time vessel operating data; and
adjusting a propeller setting responsive to real-time vessel operating data, wherein the engine setting includes at least an engine speed setting, and the propeller setting includes at least a propeller pitch setting, and wherein the propeller is adjusted independently from the engine during vessel operation.

16. The method of claim 15 wherein independently adjusting each of the engine and the propeller includes operating in a plurality of modes including at least two of:
increasing propeller pitch while maintaining engine speed;
increasing engine speed while maintaining propeller pitch;
increasing propeller pitch while decreasing engine speed;
increasing engine speed while decreasing propeller pitch;
decreasing propeller pitch while maintaining engine speed;
decreasing engine speed while maintaining propeller pitch;
decreasing engine speed while decreasing propeller pitch; and
increasing engine speed while increasing propeller pitch, wherein the modes are carried out at different operating conditions.

17. A propulsion system, comprising:
a first propulsion engine;
a second propulsion engine;
an auxiliary engine;
a first motor-generator coupled to the first propulsion engine;
a second motor-generator coupled to the second propulsion engine;
an alternator coupled to the auxiliary engine;
a first propeller having a first propeller shaft, the first propeller shaft coupled to the first motor-generator;
a second propeller having a second propeller shaft, the second propeller shaft coupled to the second motor-generator;
a battery coupled to each of the first and second motor-generators and the alternator through an electrical power distribution system; and
a control system having computer readable storage medium with code therein, the code configured to dynamically adjust settings of the first and/or second propulsion engine and the first and/or second propeller responsive to vessel operating conditions during low load operation, the operation of the engines adjusted independent of the operation of the propellers.

18. The system of claim 17 wherein the dynamic adjustment includes selectively increasing and/or decreasing propeller torque output of the first propeller by increasing and/or decreasing torque generation and/or torque absorption of the first motor-generator.

19. The system of claim 17 wherein the auxiliary engine is not mechanically coupled to the first or second propeller.

20. The system of claim 17 wherein the dynamic adjustment includes varying a distribution of torque generated by one or more of the first and second propulsion engine, auxiliary engine, and battery to one or more of the first and second propellers.

21. The system of claim 17 wherein, during an engine start, the first propulsion engine may be cranked by the first motor-generator and/or the second propulsion engine may be cranked by the second motor-generator.

22. The system of claim 21 further comprising a first clutch on the first propeller shaft and a second clutch on the second propeller shaft, the first clutch configured to decouple the first motor-generator from the first propeller, the second clutch configured to decouple the second motor-generator from the second propeller, wherein, during the engine restart, the first propulsion engine being cranked by the first motor-generator includes engaging the first clutch, and the second propulsion engine being cranked by the second motor-generator includes engaging the second clutch.

23. The system of claim 17 wherein the dynamic adjustment includes operating in at least a plurality of modes, including at least two of:
a first mode including operating both the first and second engines to power the first and second propellers, respectively, without charging the battery;
a second mode including operating both the first and second engines to power the first and second propellers, respectively, without discharging the battery for propulsion;
a third mode including operating both the first and second engines to power the first and second propellers, respectively, and further charging the battery from at least one of the first and second motor-generators;
a fourth mode including operating both the first and second engines to power the first and second propellers, respectively, and further generating torque in at least one of the first and second motor-generators through the battery;
a fifth mode including operating only the first engine to power at least both of the first and second propellers by operating at least the first motor-generator and transferring power from the first engine to the second motor-generator through the first motor-generator and the electrical power distribution system;
a sixth mode including operating only the first engine to power at least both of the first and second propellers by operating at least the second motor-generator, and transferring power from the first engine to the second motor-generator through the first motor-generator and the electrical power distribution system, and further charging the battery;
a seventh mode including operating only the first engine to power at least both of the first and second propellers by operating at least the second motor-generator, and transferring power from the first engine to the second motor-generator through the first motor-generator and the electrical power distribution system, and further discharging the battery to supplement engine output of the first engine;
an eighth mode including operating at least one of the first and second propellers with at least a respective one of the first and second motor-generators, where the battery provides power to the respective at least one motor-generator, and both the first and second engines are shutdown;
a ninth mode including operating the auxiliary engine to power an accessory load by operating at least the alternator, and transferring power from the auxiliary engine to the accessory load through the alternator and the electrical power distribution system, while operating the first or second engine to power at least both of the first and second propellers;
a tenth mode including operating only the auxiliary engine to power the accessory load and further charge the battery, while operating the first or second engine to power at least both of the first and second propellers; and
an eleventh mode including operating the first engine to power at least both of the first and second propellers and the accessory load, and further discharging the battery to power the accessory load.

24. The system of claim 17 wherein the control system dynamically adjusting operation of the propulsion system includes,
during a first condition, where there is a transient change in load experienced by the first engine, supplementing a torque output of the first engine with the first motor-generator; and
during a second condition, where there is degradation in the first or second engine, supplementing a torque output of the first or second engine with the first or second motor-generator, respectively.

25. The system of claim 24 wherein, during the first or second condition, the first or second motor-generator is powered by the battery and/or the auxiliary engine.
